(19) United States
(12) Patent Application Publication
(10) Pub. No.: US 2014/0177219 A1
(43) Pub. Date: Jun. 26, 2014

(54) Low Profile Light Fixture

(71) Applicant: ECOLITE MANUFACTURING CO., Spokane Valley, WA (US)

(72) Inventors: Timothy Lee Treto, Mead, WA (US); Edward Nicholas Caferro, Spokane, WA (US); Mark Paul Jongewaard, Arvada, CO (US); Jerry Craig Wood, Cheney, WA (US)

(73) Assignee: ECOLITE MANUFACTURING CO., Spokane Valley, WA (US)

(21) Appl. No.: 13/722,938

(22) Filed: Dec. 20, 2012

(51) Int. Cl. F21V 13/04; F21V 7/00; F21V 29/00

(52) U.S. Cl. CPC F21V 13/04; F21V 29/002; F21V 7/00
USPC 362/235; 362/249.02

(57) ABSTRACT

An ingress protected light-emitting diode (LED) fixture for outdoor and/or indoor use. In one example, a housing includes an acutely angled flange, and a plurality of LEDs fixed to an inside of the acutely angled flange. The LEDs are fixed to the acutely angled flange via a thermal interface to dissipate heat from the LEDs to the housing. An optical reflector is arranged in the housing to reflect light emitted by the LEDs. The optical reflector being customizable and having a shape specific to an application of the LED fixture. The LED fixture maintains a thin profile, making the LED fixture less susceptible to becoming accidently or intentionally damaged when mounted on low ceilings.

### BACKGROUND

Existing ingress protected lighting systems (e.g., outdoor light fixtures) may have large profiles. For example, vapor tight light fixtures may employ bulky housings and/or lenses which may be susceptible to becoming accidentally or intentionally damaged. The outdoor light fixtures may employ large light generating sources (e.g., fluorescent lights) to provide a proper amount of light. As such, the outdoor light fixtures employ bulky housings and lenses that house the large light sources to meet ingress protection requirements. For example, the outdoor vapor tight light fixtures employ housings and lenses capable of providing protection against the intrusion of solid objects, such as, hands (e.g., vandal-protected), accidental contact, dust, water, ice, etc.

Further, existing ceiling mounted ingress protected lighting systems typically employ straight down optical packages. For example, existing ingress protected lighting systems have light generating sources fixed in housings that shine substantially straight out (i.e., perpendicular to) the ceiling mounted housing. The straight down optical packages typically employ heatsinks, separate from the housing and mounted inside the housing to dissipate heat from the light generating sources fixed in the housing.

One challenge in using existing ingress protected lighting systems is that they do not provide for controlling the distribution of the light to target locations. For instance, existing ingress protected lighting systems installed on a parking garage ceiling generally direct light in a single direction.

Accordingly, there remains a need for improved ingress protected lighting systems.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 depicts a perspective exploded assembly view of an illustrative low profile light-emitting diode (LED) fixture for outdoor and/or indoor use.

FIG. 2 depicts a perspective assembly view of the illustrative low profile LED fixture illustrated in FIG. 1 installed on a ceiling.

FIG. 3 depicts a detail section view of the illustrative low profile LED fixture illustrated in FIG. 1 taken along line A-A.

FIG. 4 depicts a detail section view of another illustrative low profile LED fixture having a rectilinear lens.

### DETAILED DESCRIPTION

### Overview

Low profile light-emitting diode (LED) fixtures for outdoor and/or indoor use are described. A low profile LED fixture is configured to providing a degree of ingress protection. For example, the low profile LED fixture may be configured to provide a degree of ingress protection defined by a standards organization (e.g., International Electrotechnical Commission (IEC), National Electrical Manufactures Association (NEMA), Underwriters Laboratories (UL), Canadian Standards Association (CSA), United States Military Standard, etc.). A degree of ingress protection defines a degree of protection provided against the intrusion of objects in enclosures.

The low profile LED fixture employs a plurality of LEDs, enabling a thin profile in comparison to existing ingress protected lighting fixtures. The low profile LED fixture includes a housing arranged to dissipate heat from the plurality of LEDs fixed to the housing. The low profile LED fixture further employs customizable reflectors, enabling a controlled distribution of light. As a result, low profile LED fixtures according to this disclosure are ingress protected, provide thermal management for the plurality of LEDs, and provide customizable light control.

Because the low profile LED fixture has a compact profile, the low profile LED fixture may be installed on low ceilings (e.g., parking garage ceilings). The low profile LED fixture installed on a low ceiling provides improved vandal resistance, clean aesthetics, and little to no interruption of heating, ventilation, and air conditioning, (HVAC) systems. Further, because the low profile LED fixture utilizes LEDs, the low profile LED fixture may have a high luminous efficacy and/or efficiency compared to existing ingress protected light fixtures using fluorescent lights. In addition to providing light with less energy the LEDs have a much longer life than existing fluorescent lights. For example, the retrofit LED system may provide light for at least about 50,000 hours, 70,000 hours, 100,000 hours, or longer. In this manner, installed low profile LED fixtures are less obtrusive, and less vulnerable to impacts, while providing light with less energy (i.e., a higher luminous efficacy and/or efficiency).

Generally, a low profile LED fixture according to this disclosure has a housing that dissipates heat from a plurality of LEDs fixed to the housing via a thermal interface. The housing includes an acutely angled flange arranged around a perimeter of a base of the housing for fixing the plurality of LEDs thereto. The plurality of LEDs have a size that provides for fixing the plurality of LEDs inside the acutely angled flange. The low profile LED fixture further includes an optical reflector arranged in the housing to reflect light emitted by the LEDs fixed to the inside of the acutely angled flange.

For discussion purposes, the low profile LED fixture is described in various embodiments herein as including a plurality of LEDs fixed to a flange of a housing that dissipates heat from the plurality of LEDs. However, the plurality of LEDs may be fixed to any portion of the housing that dissipates heat from the plurality of LEDs. Further, while the low profile LED fixture is described in various embodiments herein as including LEDs, other light generating sources may be used. For example, the low profile LED fixture may include organic light-emitting diodes (OLEDs), polymer light-emitting diodes (PLEDs), phosphorescent organic light-emitting diodes (PHOLEDs) or any other suitable light source. The low profile LED fixture may use any low profile light technology suitable for providing a compact or thin profile. Further, the low profile LED fixture may be installed in any location, such as, for example, on a wall of a parking garage, a wall of a stairwell, a ceiling of a stairwell, a ceiling of a free-standing structure (e.g., a ceiling of a pavilion). Further, while the low profile LED fixture is described in various embodiments herein as having a substantially rectangular shape, other shapes are contemplated. For example, the housing may comprise a substantially curvilinear shape (e.g., round shape, half round shape, crescent shape, oval shape, etc.), triangular shape, octagonal shape, etc. For example, the housing may be substantially round and equipped with a single flange having an acute angel. The single flange may be arranged around a substantially round perimeter of a round base of the round housing, and the plurality of LEDs may be fixed to an inside of the acutely angled flange.

In some embodiments, the low profile LED fixture includes a housing having a flange arranged around a perimeter of the housing. The flange may extend in towards a middle of the perimeter of the housing and may have an acute angle. A plurality of LEDs may be fixed to an inside of the flange.

In some embodiments, the low profile LED fixture includes a base and opposing first and second flanges arranged along opposite edges of the base. The opposing first and second flanges may extend in towards a middle of the base at an acute angle. A plurality of LEDs may be fixed to an inside of the opposing first and second flanges.

In some embodiments, the low profile LED fixture includes an optical reflector arranged inside the housing. The optical reflector may be arranged to reflect light emitted by the plurality of LEDs. Alternatively, the LEDs may be fixed to a base of the housing to emit light directly out of the housing without the use of an optical reflector.

In any of the embodiments described above, the housing may be configured to dissipate heat from the plurality of LEDs fixed to the heat dissipating housing. For example, the plurality of LEDs may be fixed to the housing via a thermal interface.

### Illustrative Low Profile Light-Emitting Diode (LED) Fixture

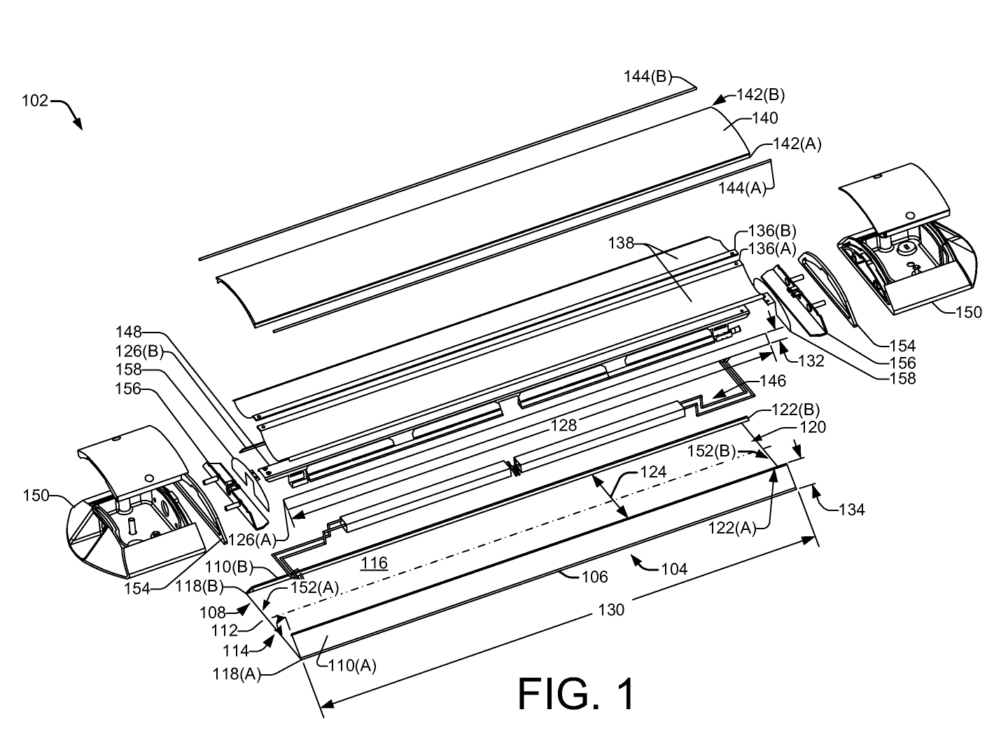

FIG. 1 depicts a perspective exploded assembly view of an illustrative low profile light-emitting diode (LED) fixture 102 for outdoor and/or indoor use. The LED fixture 102 may include a housing 104. The housing 104 may define a perimeter 106 arranged around the housing 104. The housing 104 may have a substantially rectangular shape 108, and thus the perimeter 106 may also have a substantially rectangular shape.

Flange(s) 110(A) and 110(B) may be arranged along the perimeter 106 of the housing 104. The flange(s) 110(A) and 110(B) may extend in towards a middle 112 of the perimeter 106 of the housing 104, and have an acute angle 114 relative to a base 116 of the housing 104. The base 116 may be arranged within the perimeter 106 of the housing 104. The flange(s) 110(A) and 110(B) may oppose one another, and may be arranged along opposite edges 118(A) and 118(B) of the base 116. The opposing flange(s) 110(A) and 110(B) extending in towards a middle of the base 116 at the acute angle 114 may defining a cavity 120 of the housing 104.

The flange(s) 110(A) and 110(B) may include edge(s) 122(A) and 122(B) arranged around an inside of the flange(s) 110(A) and 110(B). The edge(s) 122(A) and 122(B) arranged around the inside of the flange(s) 110(A) and 110(B) defining an aperture 124 of the housing 104.

The LED fixture 102 may include a plurality of LEDs 126(A) and 126(B) fixed to an inside wall of the flange(s) 110(A) and 110(B). For example, the plurality of LEDs 126(A) and 126(B) may be LED strips fixed to an inside wall of the flange(s) 110(A) and 110(B) via a thermal interface. The thermal interface may be a thermal adhesive, a thermal tape, thermal grease, a thermal gel, or any other thermal interface suitable to provide for or having the effect of, dissipating heat from the plurality of LEDs 126(A) and 126(B) to the housing 104. The plurality of LEDs 126(A) and 126(B) may have a length 128 that is approximately equal to a length 130 of the flange(s) 110(A) and 110(B). Further, the plurality of LEDs 126(A) and 126(B) may have a width 132 that is approximately equal to a width 134 of the flange(s) 110(A) and 110(B). In one specific example, the width 134 of the flange(s) 110(A) and 110(B) may be about 2 inches (50 millimeters). The LEDs arranged along the strips may be spaced about 2 inches (50 millimeters) apart along the length 128 of the strips of LEDs 126(A) and 126(B). In other examples the width 134 and/or the length 128 may have dimensions larger or smaller than those described.

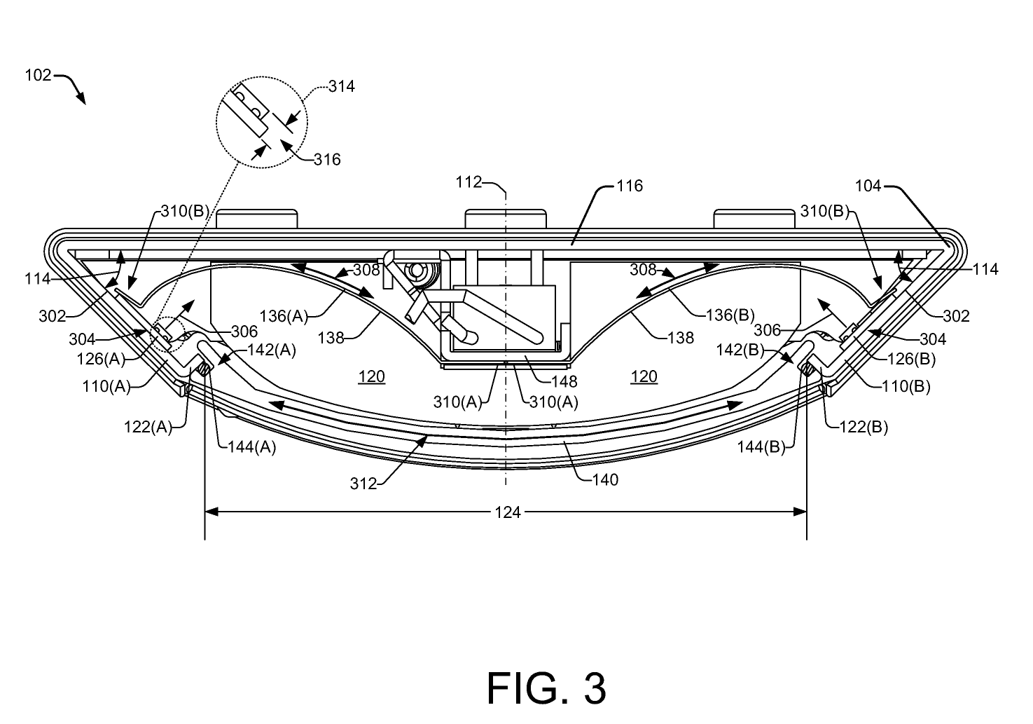

The LED fixture 102 may include optical reflector(s) 136(A) and 136(B). The optical reflector(s) 136(A) and 136(B) may be arranged to be fixed inside the perimeter 106 of the housing 104 opposite to the plurality of LEDs 126(A) and 126(B) fixed to an inside wall of the flange(s) 110(A) and 110(B). The optical reflector(s) 136(A) and 136(B) may have a reflective surface 138 arranged to reflect light emitted by the plurality of LEDs 126(A) and 126(B) out of the aperture 124 of the housing 104. For example, the optical reflector(s) 136(A) and 136(B) may have a substantially curvilinear cross-sectional area to control the light emitted by the plurality of LEDs 126(A) and 126(B) (discussed in detail below with regard to FIG. 3). For example, the curvilinear cross-sectional area may have a radius that reflects the light emitted by the plurality of LEDs 126(A) and 126(B) at an angle of reflection, towards a desired or particular direction.

The LED fixture 102 may include a lens 140. The lens 140 may be arranged to be fixed to the edge(s) 122(A) and 122(B) of the flange(s) 110(A) and 110(B). For example, the lens 140 may include edge(s) 142(A) and 142(B) configured to cooperate with the edge(s) 122(A) and 122(B) to fix the lens 140 to the housing 104. The edge(s) 142(A) and 142(B) may snap-in place with the cooperating edge(s) 122(A) and 122(B) to fix the lens 140 to the housing 104. While FIG. 1 illustrates a lens 140 and a housing 104 configured to cooperatively snap-in together, the lens 140 and the housing 104 may be configured to cooperatively press-fit together, thread together, interference fit together, etc. Further, the lens 140 may be fixed to the housing 104 via threaded fasteners, adhesives, rivets and/or any other mechanism suitable to fix the lens 140 to the housing 104.

The edge(s) 142(A) and 142(B) may include an 0-ring groove configured to retain O-ring(s) 144(A) and 144(B). The O-ring(s) 144(A) and 144(B) may provide a degree of ingress protection. For example, when the lens 140 is fixed (e.g., snapped-in) to the housing 104, the O-ring(s) 144(A) and 144(B) may be deformed or squished between the cooperating edge(s) 122(A), 122(B), 142(A), and 142(B), to seal the cavity 120 against foreign objects.

The housing 104 may be formed of metal, plastic, wood, and/or any other suitable material, to be installed outside and/or inside. For example, the housing 104 may be formed of sheet metal (e.g., aluminum sheet metal, or cold rolled steel (CRS), stainless steel, copper, brass, tin, nickel, titanium, etc.) having a thickness of about 0.04 inches (1 millimeter). Further, the flange(s) 110(A) and 110(B) may have a material thickness of about the same as the sheet metal thickness of the housing 104. For example, the housing 104 may be formed of 0.036 inch thick aluminum, and the flange(s) 110(A) and 110(B) may have a thickness of about 0.04 inches (1 millimeter). In the illustrated embodiment, the flange(s) 110(A) and 110(B) are shown as having the same sheet metal thickness as the housing 104 (e.g., 0.04 inches (1 millimeter)). However, the flange(s) 110(A) and 110(B) may be formed of any suitable thickness and/or shape effective to fix the lens 140 to the housing 104 and provide a degree of ingress protection. The housing 104, including the base 116 and the opposing first and second flange(s) 110(A) and 110(B) may be formed of a single unit of material. For example, the housing 104 may be formed of a single unit of sheet metal (e.g., aluminum sheet metal, or cold rolled steel (CRS), stainless steel, copper, brass, tin, nickel, titanium, etc.) having a thickness of about 0.04 inches (1 millimeter).

While FIG. 1 illustrates the housing 104 being formed of a single unit of aluminum, the housing 104 may be formed of a single unit of extruded metal, a single unit of a metal casting, a single unit of machined metal, or the like. For example, the housing 104 may be formed of a single unit of an extruded aluminum profile.

As illustrated in FIG. 1, the LED fixture 102 may include a driver 146 to provide power to the plurality of LEDs 126(A) and 126(B). A bracket 148 may be arranged to be fixed to the base 116 substantially proximate to the middle 112 of the housing 104. The bracket 148 may provide for cable management and/or containing or housing the driver 146. Junction box end cap(s) 150 may be fixed to opposite ends 152(A) and 152(B) of the housing 104. Gasket(s) 154 may be sandwiched between the junction box end cap(s) 150 and the end(s) 152(A) and 152(B). The gasket(s) 154 may provide a degree of ingress protection. For example, when the junction box end cap(s) 150 are fixed to the end(s) 152(A) and 152(B), the gasket(s) 154 may be deformed or squished between edges of the end(s) 152(A) and 152(B) and a surface of the junction box end cap(s) 150, to seal the cavity 120 against foreign objects.

End bracket(s) 156 and/or end reflector(s) 158 may cooperatively fix the junction box end cap(s) 150 to the driver bracket 148. The end reflector(s) may have a reflective surface arranged to reflect the light emitted by the plurality of LEDs 126(A) and 126(B).

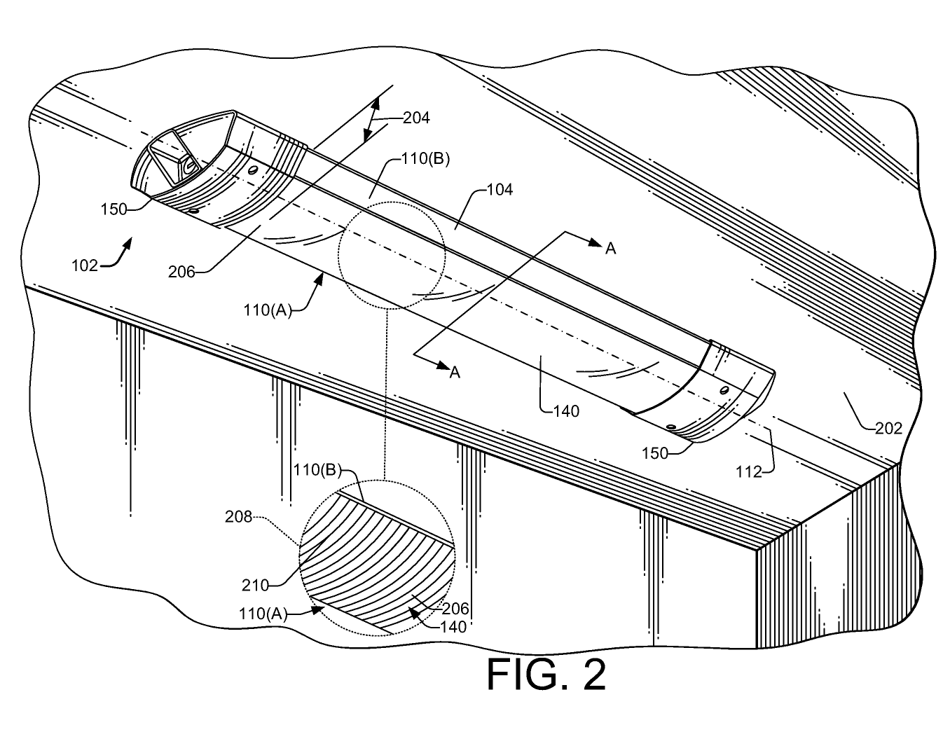

FIG. 2 depicts a perspective assembly view of the illustrative low profile LED fixture 102 illustrated in FIG. 1 installed on a ceiling 202 (e.g., a parking garage ceiling). As illustrated, the LED fixture 102 has a compact profile exhibited by a thin height 204, which allows the LED fixture 102 to be installed on the ceiling 202 without being destroyed and/or knocked down by accidental or intentional impacts. For example, the thin height 204 of the LED fixture 102 installed on the ceiling 202 may keep the LED fixture 102 out of reach of a foreign object (e.g., a hand) disposed below the ceiling 202. In one example, the thin height 204 may be a distance of at most about 1.5 inches from the ceiling 202 to an exterior surface 206 of the lens 140. Also as an example, the lens 140 may be substantially curvilinear shaped, and the height 204 may be a distance from the base 116 to a vertex or local maximum of the curved lens 140.

In addition to the thin height 204 of the low profile LED fixture 102, because the flange(s) 110(A) and 110(B) may extend in towards the middle 112 of the housing 104 at the acute angle 114, the flange(s) 110(A) and 110(B) may prevent foreign objects from grabbing, hooking, gripping, etc., the flange(s) 110(A) and 110(B). For example, the acute angle 114 may keep a hand from making static friction between the hand and the flange(s) 110(A) and 110(B). Thus, the hand slips or displaces along the flange(s) 110(A) and 110(B) with a kinetic friction, preventing the hand from gripping the flange(s) 110(A) and 110(B) or causing damage to the LED fixture 102. Similarly, the acute angle 114 may reduce a force applied from an impact of an object (e.g., an antenna of a vehicle). For example, the acute angle 114 may deflect a blunt or direct impact against the flange(s) 110(A) and 110(B), reducing the force applied from the impact of the object on the flange(s) 110(A) and 110(B).

In one example, detail view 208 depicts that the lens 140 may include ribs 210. The ribs 210 may be arranged substantially perpendicular to the opposing first and second flange(s) 110(A) and 110(B). The ribs 210 may provide for spreading or diffusing the light emitted from the plurality of LEDs 126(A) and 126(B). For example, the ribs 210 may spread or diffuse LED bright spots. FIG. 2 also illustrates a section line A-A. Section line A-A is illustrated as being taken across a middle of the LED fixture 102.

FIG. 3 depicts a detail section view of the illustrative low profile LED fixture 102 taken along section line A-A, illustrated in FIG. 2. FIG. 3 illustrates that the optical reflector(s) 136(A) and 136(B) may be fixed inside the housing 104 opposite to the plurality of LEDs 126(A) and 126(B). The plurality of LEDs 126(A) and 126(B) (e.g., a plurality of LED strips) may be fixed to an inside wall 302 of the flange(s) 110(A) and 110(B). The plurality of LEDs 126(A) and 126(B) may be fixed to the inside wall 302 of the flange(s) 110(A) and 110(B) via a thermal interface 304. The thermal interface 304 may conduct heat from the plurality of LEDs 126(A) and 126(B) to the flange(s) 110(A) and 110(B). Moreover, the plurality of LEDs 126(A) and 126(B) may be fixed to the inside wall 302 of the flange(s) 110(A) and 110(B) via the optical reflector(s) 136(A) and 136(B). For example, a portion of the optical reflector(s) 136(A) and 136(B) may interfere with a portion of the plurality of LEDs 126(A) and 126(B) to provide for forcing the plurality of LEDs 126(A) and 126(B) against the inside wall 302 of the flange(s) 110(A) and 110(B). Further, the plurality of LEDs 126(A) and 126(B) may be fixed to the inside wall 302 of the flange(s) 110(A) and 110(B) via a mechanical fastener (e.g., spring clip(s), a snap(s), bayonet(s), etc.).

The flange(s) 110(A) and 110(B) may dissipate the heat to the base 116. Because the plurality of LEDs 126(A) and 126(B) are thermally fixed to the opposing flange(s) 110(A) and 110(B), the heat transfer performance of the housing is significantly increased. For example, the flange(s) 110(A) and 110(B) provide two distinct heatsinks that allow for air flow across each of the flange(s) 110(A) and 110(B), as well as natural convection and conduction up towards the base 116.

This is compared to thermally fixing the plurality of LEDs 126(A) and 126(B) in a single row down the middle 112 of the housing 104. In this example, the plurality of LEDs 126(A) and 126(B) may be densely populated along the middle 112 of the base 116. Because the plurality of LEDs 126(A) and 126(B) may be densely populated along the middle 112 of the base 116, the plurality of LEDs 126(A) and 126(B) are only able to dissipate heat to a smaller thermal interface area, as compared to the example embodiment where the plurality of LEDs 126(A) and 126(B) are thermally fixed to the opposing flange(s) 110(A) and 110(B). Further, because the base 116 may be mounted adjacent to the ceiling 202, the base 116 may provide a heatsink with little to no airflow, and poor natural convection. This is because the interface between the base 116 and the ceiling 202 may provide little to no airflow, and the base 116 may be arranged horizontal to ceiling 202. However, in some embodiments, at least some of the LEDs may be disposed on or around the base 116 (e.g., to achieve a greater spacing between the LEDs in the housing 104).

The plurality of LEDs 126(A) and 126(B) may be arranged to emit light 306 towards the middle 112 of the housing 104 opposite the aperture 124 of the housing 104. For example, the plurality of LEDs 126(A) and 126(B) may emit light 306 substantially perpendicular to the flange(s) 110(A) and 110(B), and at an acute angle to the base 116 of the housing 104. In one embodiment, the acute angle 114 may be about 45 degrees, and the plurality of LEDs 126(A) and 126(B) emit light 306 substantially perpendicular to the flange(s) 110(A) and 110(B), and at an acute angle of about 45 degrees to the base 116 of the housing 104. In another example, the acute angle 114 may be about 35 degrees, and the plurality of LEDs 126(A) and 126(B) emit light 306 substantially perpendicular to the flange(s) 110(A) and 110(B), and at an acute angle of about 55 degrees to the base 116 of the housing 104. The acute angle 114 may be any acute angle suitable to aim the plurality of LEDs 126(A) and 126(B) generally towards the middle 112 of the housing 104.

The reflector(s) 136(A) and 136(B) may reflect the light 306 emitted by the plurality of LEDs 126(A) and 126(B). The reflector(s) 136(A) and 136(B) may have a reflective surface 138 to reflect the light 306 emitted by the plurality of LEDs 126(A) and 126(B) out of the aperture 124, and through the lens 140. The reflector(s) 136(A) and 136(B) may be fixed to the cable management bracket 148 at an end 310(A) of the reflector(s) 136(A) and 136(B), and interfere with a portion of the plurality of LEDs 126(A) and 126(B) at another end 310(B) opposite the end 310(A). The reflector(s) 136(A) and 136(B) may have a substantially curvilinear cross-sectional area 308 arranged between the ends 310(A) and 310(B). The substantially curvilinear cross-sectional area 308 may be substantially concave shaped, ear-shaped, crescent shaped, half-circle shaped, or the like. Further, the reflector(s) 136(A) and 136(B) may have a substantially rectilinear cross-sectional area arranged between the ends 310(A) and 310(B). Further, the reflector(s) 136(A) and 136(B) may be include a cross-sectional area having a shape that is specific to a particular application the LED fixture 102 may be used for. For example, the shape of the reflector(s) 136(A) and 136(B) may be customized based on a desired light pattern.

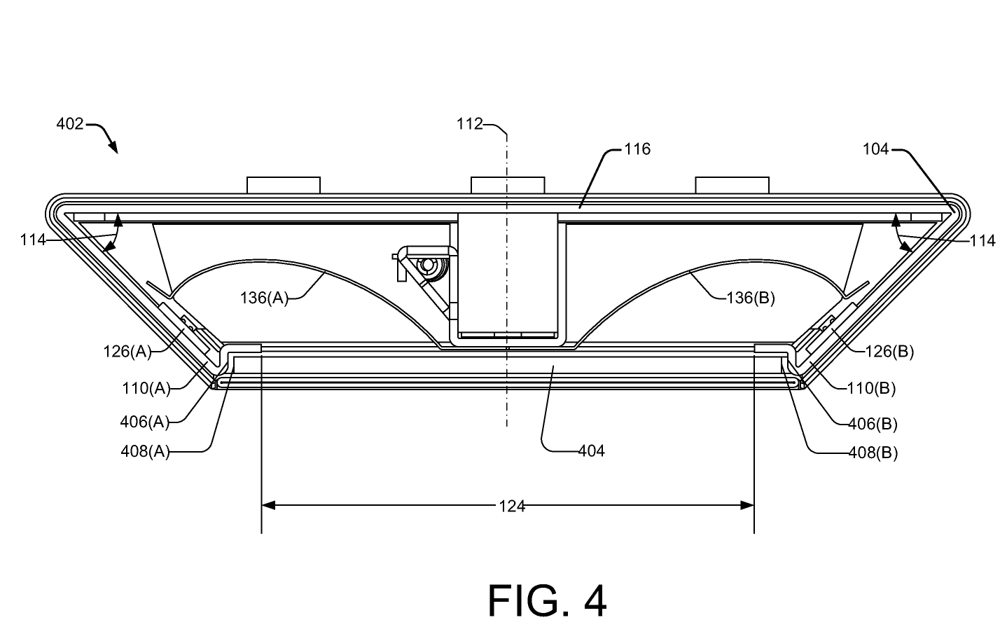

FIG. 3 illustrates the lens 140 may have a substantially curvilinear shape 312. While FIG. 3 illustrates the lens 140 having the substantially curvilinear shape 312, other shapes are contemplated. For example, the lens 140 may have a substantially rectilinear shape (discussed in detail below with regard to FIG. 4). The lens 140 may be formed of plastic. The plastic may be clear and/or opaque. For example the lens 140 may be formed of clear polycarbonate.

Detail view 314 illustrates that the plurality of LEDs 126(A) and 126(B) may have a thickness 316 ranging from about 0.2 inches (5 millimeters) to about 0.6 inches (15 millimeters). The thin thickness 316 of the plurality of LEDs 126(A) and 126(B) provides for the plurality of LEDs 126(A) and 126(B) to be comfortably fixed on the inside wall 302 of the acutely angled flange(s) 110(A) and 110(B) and maintain the thin profile of the LED fixture 102. For example, because the plurality of LEDs 126(A) and 126(B) may be comfortably fixed on the inside wall 302 of the acutely angled flange(s) 110(A) and 110(B), the LED fixture 102 maintains the overall thin height 204.

FIG. 4 depicts a detail section view of another illustrative low profile LED fixture 402 having a rectilinear lens 404. LED fixture 402 may include similar features as the LED fixture 102. For example, the LED fixture 402 may include the housing 104, and the flange(s) 110(A) and 110(B) extending in towards the middle 112 of housing 104 at the acute angle 114.

Similar to the lens 140 discussed above, the rectilinear lens 404 may be arranged to be fixed to edge(s) 406(A) and 406(B) of the flange(s) 110(A) and 110(B). For example, the rectilinear lens 404 may include edge(s) 408(A) and 408(B) configured to cooperate with the edge(s) 406(A) and 406(B) to fix the rectilinear lens 404 to the housing 104. The rectilinear lens 404 may include the ribs 210 arranged substantially perpendicular to the opposing first and second flange(s) 110(A) and 110(B).

### CONCLUSION

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. For example, in various embodiments, any of the structural features and/or methodological acts described herein may be rearranged, modified, or omitted entirely. For example, the shape, size, and configuration of the LED fixtures may be varied.

What is claimed is:

1. A low profile light-emitting diode (LED) fixture comprising:
a housing defining a perimeter and having a flange arranged around the perimeter, the flange extending in towards a middle of the perimeter of the housing and having an acute angle relative to a base of the housing, the flange comprising an edge arranged around an inside of the flange defining an aperture of the housing;
a plurality of LEDs fixed to an inside wall of the flange and arranged to emit light in towards the middle of the perimeter of the housing opposite the aperture of the housing; and
an optical reflector fixed inside the perimeter of the housing opposite to the plurality of LEDs fixed to the inside wall of the flange, the optical reflector having a reflective surface arranged to reflect the light emitted by the LEDs out of the aperture of the housing.

2. The low profile LED fixture according to claim 1, wherein the housing is formed of a metal and dissipates heat from the plurality of LEDs fixed to the inside wall of the flange.

3. The low profile LED fixture according to claim 1, wherein the plurality of LEDs are fixed to the inside wall of the flange via a thermal interface.

4. The low profile LED fixture according to claim 3, wherein the thermal interface comprises a thermal adhesive or a thermal tape.

5. The low profile LED fixture according to claim 1, wherein the optical reflector has a substantially curvilinear cross-sectional area.

6. A low profile light-emitting diode (LED) fixture to be installed on a ceiling, the low profile LED fixture comprising:
a housing including a base and opposing first and second flanges arranged along opposite edges of the base, the opposing first and second flanges extending in towards a middle of the base at an acute angle relative to the base and defining a cavity of the housing;
a plurality of LEDs fixed to an inside wall of the opposing first and second flanges and arranged to emit light in towards the base; and
one or more optical reflectors fixed in the cavity of the housing and arranged to reflect light emitted by the plurality of LEDs out of the cavity of the housing.

7. The low profile LED fixture according to claim 6, further comprising a lens fixed to edges of the opposing first and second flanges opposite the base.

8. The low profile LED fixture according to claim 7, wherein the lens has a substantially rectilinear cross-sectional shape and is disposed between the opposing first and second flanges.

9. The low profile LED fixture according to claim 7, wherein the lens has a substantially curvilinear cross-sectional shape and is disposed between the opposing first and second flanges.

10. The low profile LED fixture according to claim 7, wherein an exterior surface of the lens is at most about 1.5 inches from the ceiling.

11. The low profile LED fixture according to claim 7, wherein the lens is a ribbed lens.

12. The low profile LED fixture according to claim 11, wherein the ribs are arranged substantially perpendicular to the opposing first and second flanges.

13. A low profile light-emitting diode (LED) fixture to be installed on a ceiling, the low profile LED fixture comprising:
a heat dissipating housing comprising:
a base arranged to be adjacent to the ceiling; and
opposing first and second flanges arranged along opposite edges of the base, the opposing first and second flanges extending in towards a middle of the base at an acute angle relative to the base;
a plurality of LEDs fixed to an inside wall of the opposing first and second flanges; and
wherein the plurality of LEDs are fixed to the inside walls of the opposing first and second flanges via a thermal interface, and the opposing first and second flanges dissipate heat from the plurality of LEDs to the base arranged to be adjacent to the ceiling.

14. The low profile LED fixture according to claim 13, wherein the thermal interface comprises a thermal adhesive.

15. The low profile LED fixture according to claim 13, wherein the thermal interface comprises a thermal tape.

16. The low profile LED fixture according to claim 13, wherein the plurality of LEDs comprise unitary strips of LEDs having a length of at most about a length of the opposing first and second flanges, and a width of at most about a width of the inside walls of the opposing first and second flanges.

17. The low profile LED fixture according to claim 13, wherein the housing, comprising the base and the opposing first and second flanges, is formed of a single unit of material.

18. The low profile LED fixture according to claim 17, wherein the material comprises metal.

19. The low profile LED fixture according to claim 13, wherein the base and the opposing first and second flanges comprise a material thickness of about 0.04 inches (1 millimeter).

20. The low profile LED fixture according to claim 13, wherein the opposing first and second flanges have a width of about 2 inches (50 millimeters).
